(19) United States
(12) Patent Application Publication
(10) Pub. No.: US 2006/0063124 A1
(43) Pub. Date: Mar. 23, 2006

(54) Impression tray set

(76) Inventor: Marc-Antoine Barraya, Saint Andre (FR)

Correspondence Address: YOUNG & THOMPSON, 745 SOUTH 23RD STREET, 2ND FLOOR, ARLINGTON, VA, 22202, US

(21) Appl. No.: 10/543,609

(22) PCT Filed: Oct. 20, 2003
(86) PCT No.: PCT/FR03/03085

§ 371 Date: Jul. 28, 2005

(30) Foreign Application Priority Data
Oct. 28, 2002 (FR) 02/13422

(51) Int. Cl. A61C 9/00

(52) U.S. Cl. 433/45

(57) ABSTRACT

The invention concerns an impression tray set for recording dental arch volumes of the lower and upper maxillary, characterized in that it comprises for each maxillary: at least one first impression tray support (1) made of sterilizable material, for use in the dental surgery, including a cavity for removably receiving: a disposable impression tray (4) in the form of a receptacle for receiving the paste (6) designed to record the volumes of the dental arch and to be transferred, without the support of the impression tray (1) to the prosthesis laboratory.

The impression tray now used in dental practice is the indispensable and irreplaceable tool to record by impression in a suitable paste, the volumes of the dental arches.

The object of this impression tray is to permit the practitioner to bring to the mouth of the patient the different materials (silicones, alginates, hydrocolloids, etc.) necessary to make the mentioned impressions.

The impression tray used at present is made of a single piece either of metal or of so-called disposable plastic material.

This impression tray is adapted to the shape of the mandible and of the maxillary of the patient who can be with or without teeth, partially or totally.

The present impression tray is necessarily rigid to avoid any deformation during its emplacement or its removal from the mouth of the patient.

Moreover, this impression tray is sterilizable.

The impression tray used at present has a certain number of drawbacks.

First of all, this impression tray is never sterilized, whilst all the other instruments or dental tools are systematically sterilized, which may seem to be astonishing. Practice shows moreover that the disposable impression trays of plastic material are most often reused and cannot be sterilized because of their composition.

Furthermore, present impression trays are very difficult to clean. Thus, the impression pastes are very resistant and the adhesives require much time and effort of the dental assistant or the prosthesist to render the impression tray clean and reusable.

Moreover, present impression trays are costly to clean. Their cleaning thus requires passages through cleaning baths and ultrasonic baths before returning to the prosthesis laboratory.

Finally, the impression tray is often lost particularly during its transfer between the dental office and the prosthetic laboratory.

Examples of dental trays are also described in U.S. Pat. Nos. 5,076,785 and 6,302,689 and in PCT/WO88/06869.

The object of the present invention is to overcome the drawbacks of known impression trays.

The invention thus proposes an impression tray set adapted to record the volumes of the dental arch of the upper and lower maxillary, characterized in that it comprises for each maxillary at least one first impression tray support of sterilizable material, adapted to be used at the dentist's office, comprising a cavity adapted to receive removably a single use impression tray in the form of a receptacle, adapted to receive the paste that is to record the volumes of the dental arch and to be transferred, without the impression tray support, to the prosthesis laboratory.

Preferably, this impression tray set comprises moreover a second impression tray support, adapted to be used at the prosthesis laboratory, comprising a cavity adapted to receive removably said single use impression tray comprising said paste in which the volumes of the dental arch have been recorded.

Thus, the impression tray set according to the invention comprises three elements of which the essential element is a single use impression tray, which is to say disposable after each use.

The first impression tray support remains permanently at the dental office such that there is no risk of its being lost, whilst only the single use impression tray is transferred to the prosthesis laboratory. The prosthesis laboratory places the impression tray filled with paste carrying the impression of the dental arch, on a second support which remains permanently in the prosthesis laboratory.

The invention thus permits solving the problems of cost, cleaning, sterilization and risk of loss of the impression tray.

According to a preferred embodiment of the invention, the first impression tray support comprises on the bottom of its cavity a series of protuberances regularly distributed and spaced, whose summit serves as a support for the bottom of the single use impression tray, and the bottom of the single use impression tray comprises holes which, when the bottom of the impression tray bears against said protuberances, are located between these latter.

Thanks to these arrangements, the protuberances permit spacing the bottom of the impression tray from the bottom of the impression tray support and the holes provided in the bottom of the impression tray permit the passage of the paste and thus the retention of this latter relative to the bottom of this impression tray.

Other characteristics and advantages of the invention will become apparent from the following description.

In the accompanying drawings, given by way of non-limiting example:

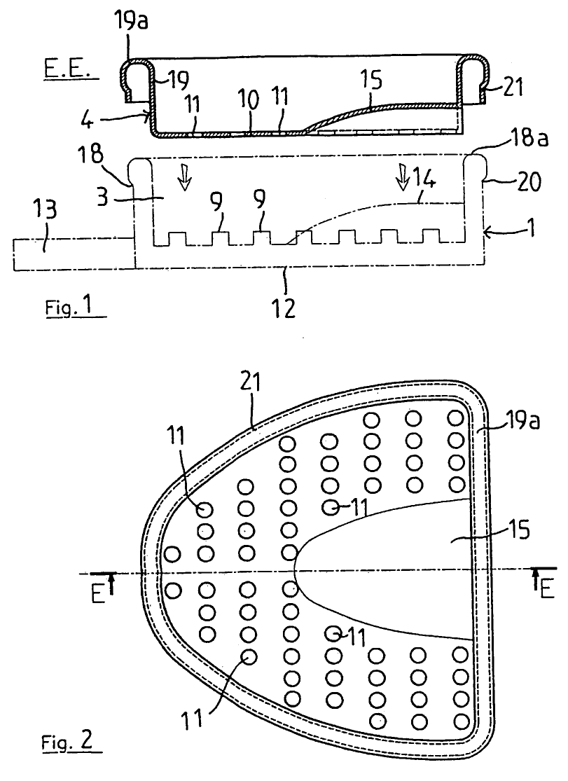

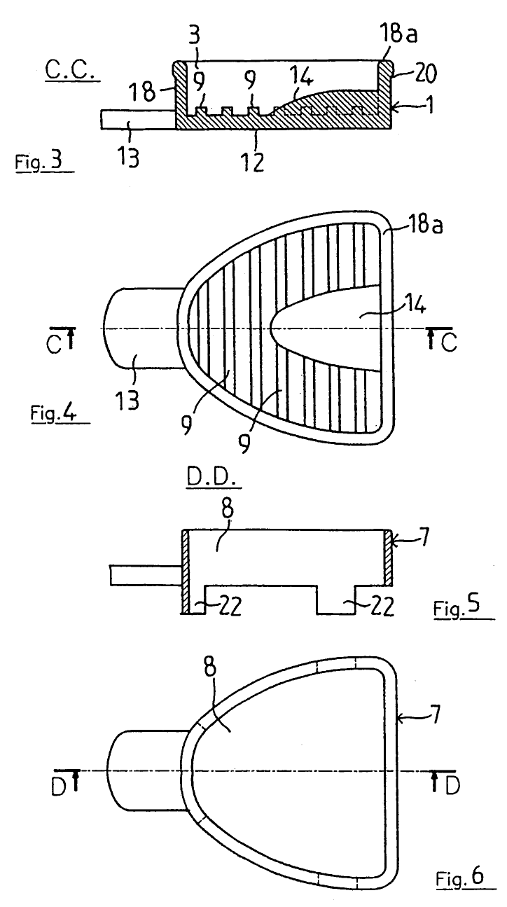

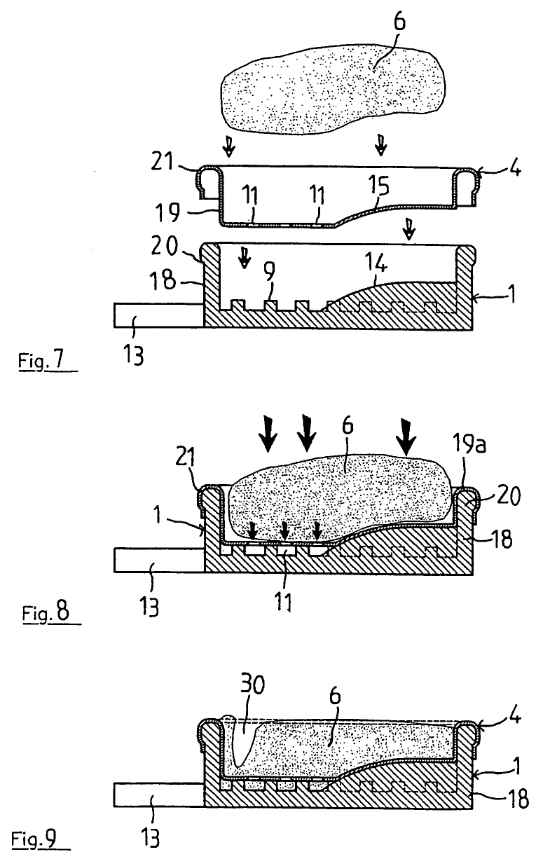

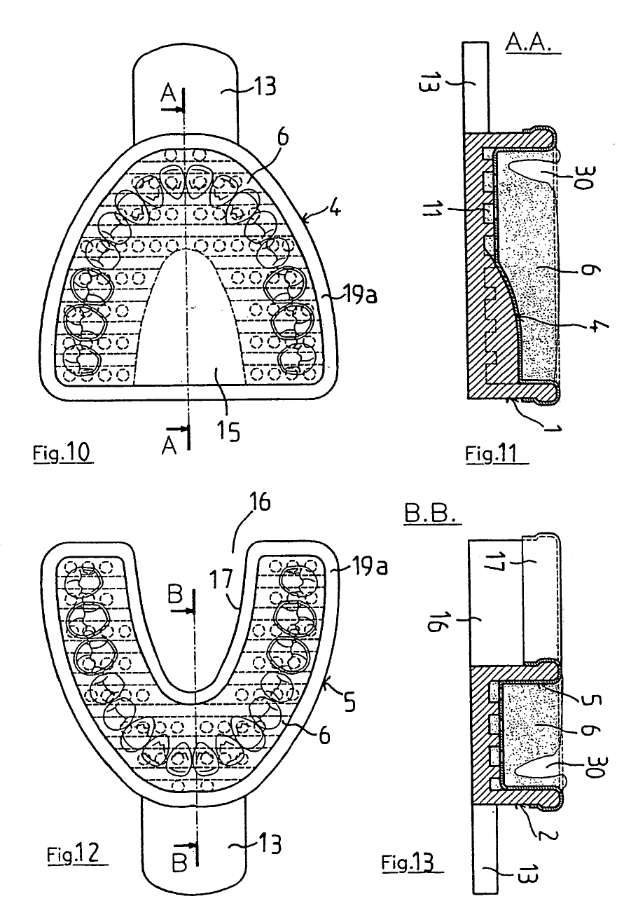

FIG. 1 is a cross-sectional view on the line E-E of FIG. 2, of a single use impression tray according to the invention and (in broken lines) an impression tray support adapted to be used in the dental office.

FIG. 2 is a plan view from above of the single use impression tray of FIG. 1.

FIG. 3 is a cross-sectional view on the line C-C of FIG. 4, of an impression tray support according to the invention.

FIG. 4 is a top plan view of the impression tray support of FIG. 3.

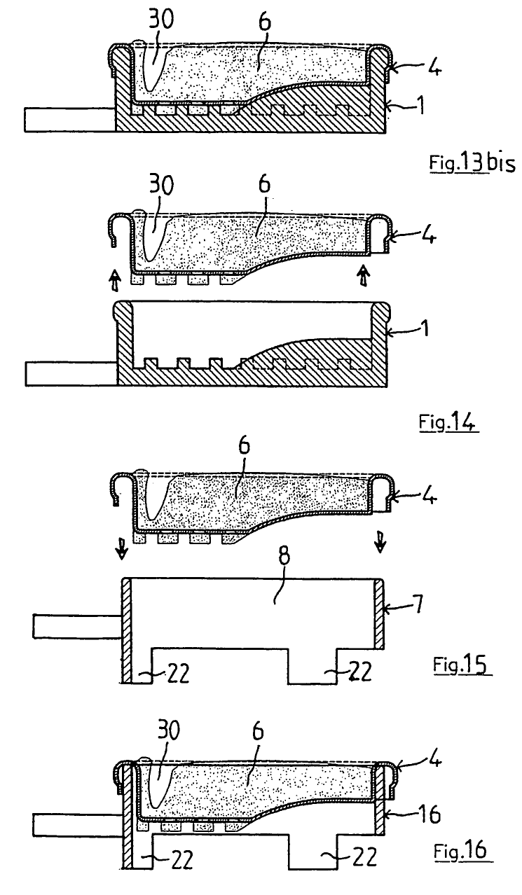

FIG. 5 is a cross-sectional view on the line D-D of FIG. 6, of an impression tray support adapted to be used in the prosthesis laboratory.

FIG. 6 is a top plan view of the impression tray support according to FIG. 5.

FIG. 7 is a cross-sectional view of an impression tray support for the dental office, of an impression tray adapted to be placed in the support, and of the paste designed to record the volumes of the dental arch.

FIG. 8 is a view similar to FIG. 7 showing the impression tray in position in the impression tray support and the paste disposed in the impression tray.

FIG. 9 is a view similar to FIG. 8 showing the imprint of the dental arch recorded in the paste.

FIG. 10 is a top plan view of an impression tray for the upper maxillary having the corresponding impression of the dental arch, this impression tray being disposed in the corresponding dental tray support.

FIG. 11 is a cross-sectional view on the line A-A of FIG. 10.

FIG. 12 is a view similar to FIG. 10 showing an impression tray for the lower maxillary disposed on the corresponding impression tray support.

FIG. 13 is a cross-sectional view on the line B-B of FIG. 12.

FIG. 13b is is a view showing the impression tray in position on the impression tray support used at the dental office.

FIG. 14 is a view analogous to FIG. 9 showing the ultimate step in which the impression tray comprising the paste in which has been made the dental arch impression, is detached from the impression tray support to be transferred to the prosthesis laboratory.

FIG. 15 shows the ultimate step in which the impression tray transferred to the prosthesis laboratory is placed on the impression tray support used in the prosthesis laboratory.

FIG. 16 is a view similar to FIG. 15 showing the impression tray in position on the impression tray support used in the prosthesis laboratory.

In the embodiment shown in the accompanying figures, the impression tray set adapted to record the volumes of the dental arch of the upper and lower maxillary, comprises for each maxillary (see particularly FIGS. 1, 3 and 13),
a first impression tray support 1, 2 of sterilizable material, adapted to used at the dental office, comprising a cavity 3 adapted to receive renewably,
an single use impression tray 4, 5 in the form of a receptacle, adapted to receive the paste 6 which is to record the volumes of the dental arch and to be transferred, without the impression tray support 1, 2, to the prosthesis laboratory, and
a second impression tray support 7 (see FIGS. 5 and 15), adapted to used at the prosthesis laboratory, comprising a cavity 8 adapted to receive removably said single use impression tray 4, 5 containing the paste 6 in which the volumes of the dental arch have been recorded.

Thus the impression tray support 1, 2 never leaves the dental office. Only the impression tray 4, 5 is transferred to the prosthesis laboratory.

The first impression tray support 1, 2 comprises on the bottom of its cavity 3 a series of protuberances or ribs 9 (see FIGS. 1, 3, 4) regularly distributed and spaced, whose summit serves to support the bottom 10 of the single use impression tray 4 or 5.

The ribs 9 are for example spaced 3 mm apart and have a height of about 1.5 mm.

Moreover, the bottom 9 of the single use impression tray 4 or 5 comprises holes 11 which, when the bottom of the impression tray bears on said protuberances, are located between these latter, as shown for example in FIG. 9.

Still further, the first impression tray support 1, 2 comprises a flat bottom 12 prolonged by a handle 13 (see in particular FIGS. 3 and 13).

FIGS. 1, 3 and 4 show in particular that the first impression tray support 1 adapted for the upper maxillary, comprises on its bottom a projection 14 adapted to the shape of the pallet.

Similarly, the single use impression tray 4 adapted for the upper maxillary comprises (see FIGS. 1 and 2) on its bottom a projection 15 of a shape complementary to the projection 14 on the bottom of said first impression tray support adapted for the upper maxillary.

Furthermore, as shown particularly in FIGS. 12 and 13, the first impression tray support 2 for the lower maxillary comprises on its rear surface a recess 16 adapted to the shape of a tongue.

Similarly, the single use impression tray 5 adapted for the lower maxillary comprises on its rear surface a recess 17 of a shape complementary to the recess 16 of said first impression tray support 2 adapted for the lower maxillary.

Furthermore, the upper edge 18a of the sidewall 18 which delimits the cavity 3 of the first impression tray support 1 or 2 and the upper edge 19a of the lateral wall 19 which delimits externally the single use impression tray 4 or 5, comprise supplemental securement means coacting by snapping in.

In the illustrated embodiment, said supplemental securement means comprise on the upper edge 18a of the first impression tray support 1 or 2, a shoulder 20 extending over all the periphery of the external surface of the sidewall 18 of the first support, and on the upper edge 19a of the single use impression tray, a downwardly directed flange 21 to cover the upper edge 18a of the first support 1 or 2 and adapted to snap in below the shoulder 20 of the first impression tray support 1 or 2, as shown for example in FIG. 8.

FIG. 2 shows particularly that the flange 21 extends over all the periphery of the single use impression tray 4 or 5.

As shown in FIGS. 5 and 15, the second impression tray support 7 for the prosthesis laboratory is constituted by an upwardly and downwardly opening receptacle of a shape adapted to receive the single use impression tray 4, 5 as shown in FIG. 16. Moreover, this second support 7 comprises feet 22 to hold the open bottom of said receptacle at a certain distance from the working plane.

There will now be explained with reference to FIGS. 7 to 16 the different phases of use of the impression tray set according to the invention.

As shown in FIG. 7, in a first phase, the single use impression tray 4 is introduced into the corresponding impression tray support 1. There is then placed in the single use impression tray 4 the paste 6 in which will be produced the impression of the dental arch. In this example, it is the upper maxillary the impression of whose dental arch is to be taken.

In the phase illustrated in FIG. 8, the paste 6 is pressed into the interior of the impression tray 4 such that the upper surface of this paste 6 will be substantially at the level of the upper edge 19a of the impression tray 4.

The set can then be introduced into the mouth of the patient.

FIG. 9 shows the result obtained, which is to say the impression 30 of the dental arch made in the paste 6. It will be seen in particular that the paste 6 because of the pressure applied to it, has passed through the holes 11 at the bottom of the impression tray 4 and has penetrated into the spaces comprised between the ribs 9 provided at the bottom of the impression tray support 1.

It will also be seen in FIGS. 8 and 9 that the upper edge 19a of the impression tray 4 is fixed on the sidewall 18 of the impression tray support 1 by snapping in below a shoulder 20 provided on the periphery of this sidewall 18.

In the phase shown in FIG. 14, the impression tray 4 enclosing the paste 6 in which has been formed the dental impression 30, is removed from the support 1.

This impression tray 4 filled with paste 6 and having the impression 30 is then transferred to the prosthesis laboratory.

In the phase shown in FIG. 15, the prosthesist places the impression tray 4 filled with paste 6 in the support 7.

When the impression tray 4 is in position in the support 7 as shown in FIG. 16, the prosthesist can pour into the dental impression 30 a suitable molding material which after hardening and de-molding will itself serve to produce the prosthesis required by the dental office.

At the end of use, the impression tray 4 enclosing the paste is discarded, which avoids the operations of cleaning and sterilization.

Thus, the dental office for each operation will use an impression tray 4, 5 or 9 which has been previously sterilized.

The impression support 1 or 2 does not require any cleaning because it does not enter into contact with the paste 6. Moreover, given that the impression tray support 1 or 2 remains at the dentist's office, there is no risk of being lost during transfer to the prosthesist's laboratory.

The impression tray support 1 or 2 can be made of a plastic sterilizable material or of metal. It can be made in of course different sizes for adults plus one size for children. So as to differentiate the different sizes, the support can be of a different color for each size.

The single use impression tray 4 or 5 is made of a biocompatible plastic material of relatively small thickness, for example equal to 0.5 mm.

The cost of production of this impression tray is relatively low, such that it can be discarded after each use.

The holes 11 provided in the bottom of the impression tray 4 or 5 permit a retention of the paste 6 in the impression tray.

The impression tray support 7 used in the prosthesis laboratory remains permanently in this laboratory.

It has the same size and the same color as the corresponding impression tray support used in the dentist's office.

The impression tray support used in the prosthesis laboratory can be made of a rigid plastic material which need not be biocompatible or sterilizable.

It comprises moreover preferably a handle as shown.

The impression tray 4 or 5 can after use by the prosthesist be discarded by this latter or be transferred to the dental office for control by the practitioner.

1. Impression tray set adapted to record the volumes of the upper and lower maxillary dental arch, characterized in that it comprises for each maxillary: at least one first impression tray support (1, 2) from a sterilizable material, adapted to be used at the dental office, comprising a cavity (3) adapted to receive removable, a single use impression tray (4, 5) in the form of a receptacle, adapted to receive the paste (6) that records the volumes of the dental arch and to be transferred, without the impression tray support (1, 2) to the prosthesis laboratory.

2. Impression tray set according to claim 1, characterized in that it moreover comprises a second impression tray support (7), adapted to be used at the prosthesis laboratory, comprising a cavity (8) adapted to receive removably said single use impression tray (4, 5) comprising said paste (6) in which the volumes of the dental arch have been recorded.

3. Impression tray set according to claim 1, characterized in that the first impression tray support (1, 2) comprises on the bottom of its cavity a series of protuberances (9) regularly distributed and spaced, whose summit serves as a support for the bottom (10) of the single use impression tray (4, 5).

4. Impression tray set according to claim 3, characterized in that the bottom of the single use impression tray (4, 5) comprises holes (11) which, when the bottom of the impression tray bears on said protuberances (9), are located between these latter.

5. Impression tray set according to claim 1, characterized in that the first impression tray support (1, 2) comprises a flat bottom (12) prolonged by a handle (13).

6. Impression tray set according to claim 1, characterized in that the first impression tray support (1) adapted for the upper maxillary comprises on its bottom a projection (14) shaped like a pallet.

7. Impression tray set according to claim 6, characterized in that said single use impression tray (4) adapted for the upper maxillary comprises on its bottom a projection (15) of a shape complementary to the projection (14) on the bottom of said first impression tray support (1) adapted for the upper maxillary.

8. Impression tray set according to claim 1, characterized in that the first impression tray support (1) adapted for the lower maxillary comprises on its rear surface a recess (16) adapted for the shape of the tongue.

9. Impression tray set according to claim 8, characterized in that said single use impression tray (4) for the lower maxillary comprises on its rear surface a recess (17) of a shape complementary to the recess (16) of said first impression tray support (1) adapted for the lower maxillary.

10. Impression tray set according to claim 1, characterized in that the upper edge (18a) of the sidewall (18) which limits the cavity (3) of said first impression tray support (1) and the upper edge (19a) of the sidewall (18) which limits externally said single use impression tray (4), comprise complementary securement means coacting by snapping in.

11. Impression tray set according to claim 10, characterized in that said complementary securement means comprise on the upper edge (18a) of the first impression tray support (1) a shoulder (20) extending over all the periphery of the external surface of the sidewall of said first support, and on the upper edge (19a) of said single use impression tray (4) a flange (21) directed downwardly to cover the upper edge (18a) of the first support and adapted to snap over the shoulder (20) of the first impression tray support.

12. Impression tray set according to claim 11, characterized in that said flange (21) extends over all the periphery of said single use impression tray (4).

13. Impression tray set according to claim 1, characterized in that the second impression tray support (7) adapted for the prosthesis laboratory is constituted by an upwardly and downwardly open receptacle of a shape adapted to receive said single use impression tray (4).

14. Impression tray set according to claim 13, characterized in that it comprises feet (22) to hold the open bottom of said receptacle at a certain distance from the working plane.

15. Impression tray set according to claim 2, characterized in that the first impression tray support (1, 2) comprises on the bottom of its cavity a series of protuberances (9) regularly distributed and spaced, whose summit serves as a support for the bottom (10) of the single use impression tray (4, 5).

16. Impression tray set according to claim 2, characterized in that the first impression tray support (1, 2) comprises a flat bottom (12) prolonged by a handle (13).

17. Impression tray set according to claim 3, characterized in that the first impression tray support (1, 2) comprises a flat bottom (12) prolonged by a handle (13).

18. Impression tray set according to claim 4, characterized in that the first impression tray support (1, 2) comprises a flat bottom (12) prolonged by a handle (13).

19. Impression tray set according to claim 2, characterized in that the first impression tray support (1) adapted for the upper maxillary comprises on its bottom a projection (14) shaped like a pallet.

20. Impression tray set according to claim 3, characterized in that the first impression tray support (1) adapted for the upper maxillary comprises on its bottom a projection (14) shaped like a pallet.
